(19) United States
(12) Patent Application Publication
(10) Pub. No.: US 2023/0281947 A1
(43) Pub. Date: Sep. 7, 2023

(54) IMAGE PROCESSING DEVICE, IMAGE PROCESSING METHOD, AND NON-TRANSITORY COMPUTER READABLE STORAGE MEDIUM

(71) Applicant: CANON KABUSHIKI KAISHA, Tokyo (JP)

(72) Inventor: SHINJI YAMAMOTO, Kanagawa (JP)

(21) Appl. No.: 18/172,504

(22) Filed: Feb. 22, 2023

(30) Foreign Application Priority Data
Mar. 7, 2022 (JP) 2022-034769

(51) Int. Cl. G06V 10/26; G06T 7/90; G06T 7/73; G06T 7/11; G06T 7/136; G06V 40/10; G06T 7/60

(52) U.S. Cl. CPC G06V 10/26; G06T 7/11; G06T 7/136; G06T 7/60; G06T 7/74; G06T 7/90; G06V 40/10; G06T 2207/20021; G06T 2207/20081; G06T 2207/30196

(57) ABSTRACT

There is provided with an image processing device. A determination unit determines, in a case where a reference person on an image is concealed by another person, a part or all of a region of the other person on the image as a processing region in accordance with a state of the concealment. An estimation unit estimates a joint point of the reference person on a processed image obtained by performing a process of processing the processing region on the image.

### BACKGROUND OF THE INVENTION

### Field of the Invention

The present invention relates to an image processing device, an image processing method, and a non-transitory computer readable storage medium.

### Description of the Related Art

In order to detect an action and a situation of a person, a technology for detecting joint points of the person in an image has been developed. This technology can be utilized for form analysis of sports, work analysis of workers working in factories, and the like. However, in a case where persons overlap each other on the image, both persons have features to be detected. Thus, even when the image processing device tries to detect the joint points of a reference person, the image processing device may erroneously detect the joint points of the other person. Thus, even when the joint points of the reference person is concealed by the other person, it is required to detect the joint points of the reference person.

In view of the above problem, a method is generally used, in which detection accuracy of the joint points of a predetermined person is improved by performing learning using learning data in a case where the joint points of the predetermined person are concealed. Japanese Patent Laid-Open No. 2015-80220 discloses a method for improving the detection accuracy of the joint points of the person by synthesizing a mask at a random position in the image in the learning data and causing the joint points of the person to be concealed in a pseudo manner. Further, there is also disclosed a method of changing image processing measures in a case where a plurality of the persons are detected in the mask (Japanese Patent Laid-Open No. 2015-80220).

### SUMMARY OF THE INVENTION

The present invention in its one aspect provides an image processing device comprising a determination unit configured to determine, in a case where a reference person on an image is concealed by another person, a part or all of a region of the other person on the image as a processing region in accordance with a state of the concealment, and an estimation unit configured to estimate a joint point of the reference person on a processed image obtained by performing a process of processing the processing region on the image.

The present invention in its one aspect provides an image processing method comprising determining, in a case where a reference person on an image is concealed by another person, a part or all of a region of the other person on the image as a processing region in accordance with a state of the concealment, and estimating a joint point of the reference person on a processed image obtained by performing a process of processing the processing region on the image.

The present invention in its one aspect provides a non-transitory computer-readable storage medium storing a program that, when executed by a computer, causes the computer to perform an image processing method comprising determining, in a case where a reference person on an image is concealed by another person, a part or all of a region of the other person on the image as a processing region in accordance with a state of the concealment, and estimating a joint point of the reference person on a processed image obtained by performing a process of processing the processing region on the image.

Further features of the present invention will become apparent from the following description of exemplary embodiments (with reference to the attached drawings).

### BRIEF DESCRIPTION OF THE DRAWINGS

FIG. 1 is a diagram illustrating an example of hardware configuration of an image processing device according to a first embodiment.

FIG. 2 is a block diagram illustrating an example of a functional configuration of the image processing device according to the first embodiment.

FIG. 3 is a diagram illustrating an example of a detection result of persons on an image according to the first embodiment.

FIG. 4 is a diagram illustrating an example of a detection result of persons on an image according to the first embodiment.

FIG. 5 is a diagram illustrating an example of an overlap information according to the first embodiment.

FIG. 6 is a diagram illustrating an example of processing information according to the first embodiment.

FIG. 7 is a diagram illustrating an example of a processed image according to the first embodiment.

FIG. 8 is a flowchart illustrating a flow of image processing according to the first embodiment.

FIG. 9 is a block diagram illustrating an example of a functional configuration of an image processing device according to a second embodiment.

FIG. 10 is a flowchart explaining a flow of image processing according to the second embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

According to the present invention, accuracy of detecting a joint point of a person can be improved.

### First Embodiment

In a case where a reference person on an image is concealed by another person, an image processing device determines a part or all of a region of the other person on the image as a processing region in accordance with a state of the concealment. The image processing device estimates a joint point of the reference person on a processed image obtained by performing a process of processing a processing region on the image. Note that the present embodiment can be used as a posture analysis system in which the image processing device and an image capturing device are combined. In the present embodiment, the joint point of the person is an estimation target, but the present invention is not limited thereto. For example, a joint point of an animal may be the estimation target.

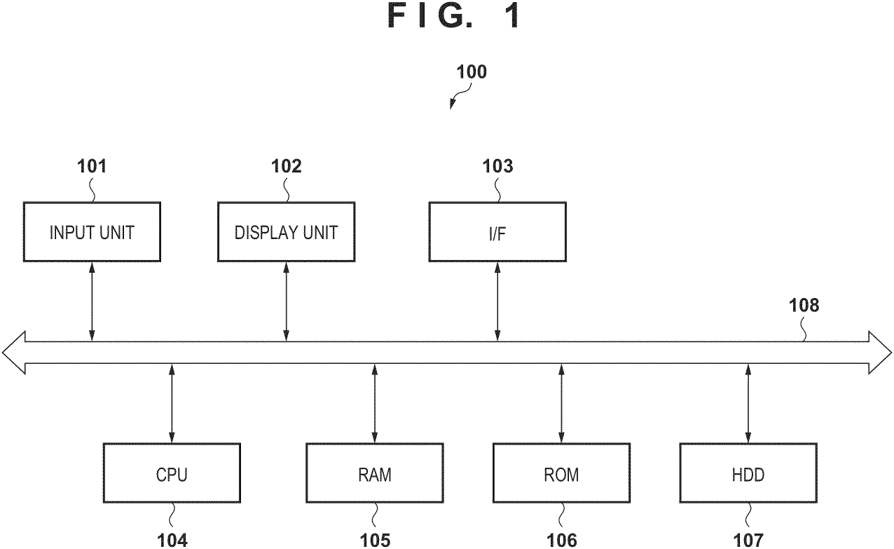

FIG. 1 is a diagram illustrating an example of hardware configuration of the image processing device according to a first embodiment. An image processing device 100 includes an input unit 101, a display unit 102, an I/F 103, a CPU 104, a RAM 105, a ROM 106, an HDD 107, and a data bus 108.

The input unit 101, which is a device configured to input various data by a user, includes, for example, a keyboard, a mouse, a touch panel or the like.

The display unit 102, which is a device configured to display the various data, includes, for example, a liquid crystal display (LCD). The display unit 102 is connected to the input unit 101 and the display unit 102 via the data bus 108.

The I/F 103 transmits and receives various information between the image processing device 100 and another device (not illustrated) via a network (not illustrated) such as the Internet or the like.

The CPU 104 is a processor configured to perform overall control of each unit in the image processing device 100. The CPU 104 performs various controls by reading a control program in the ROM 106, loading the program into the RAM 105, and executing the program. The CPU 104 executes an image processing program in the ROM 106 and the HDD 107 to implement image processing on the image data.

The RAM 105 is a temporary storage area for the program executed by the CPU 104, a work memory, and the like.

The ROM 106 stores a control program for controlling each unit in the image processing device 100.

The HDD 107, which is a device configured to store various data, stores, for example, an image data, a setting parameter, various programs, and the like. In addition, the HDD 107 can also store data from an external device (not illustrated) via the I/F 103.

A data bus 108, which is a transmission path configured to transmit data, transmits image data and the like, which is received from the external device via the I/F 103, to the CPU 104, RAM 105, and ROM 106. The data bus 108 transmits the image data and the like from the image processing device 100 to the external device.

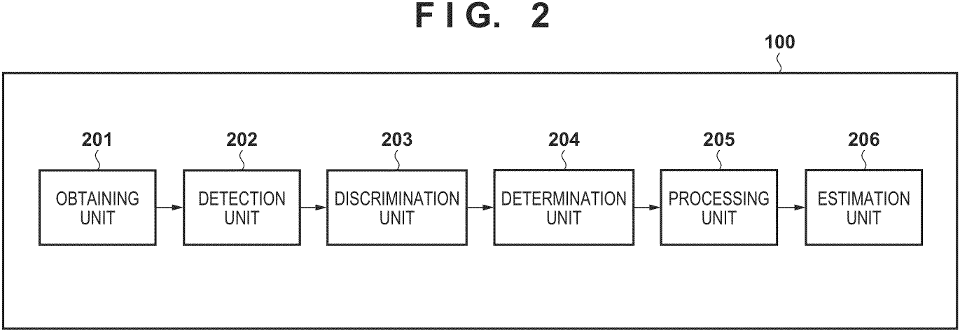

FIG. 2 is a block diagram illustrating an example of a functional configuration of the image processing device according to the first embodiment. The image processing device 100 includes an obtaining unit 201, a detection unit 202, a discrimination unit 203, a determination unit 204, a processing unit 205, and an estimation unit 206.

The obtaining unit 201 obtains an image from the HDD 107 or the like. The image is an image captured by an image capturing device (such as a security camera) (not illustrated), an image already stored in the HDD 107 or the like, or an image received via the network such as the Internet. The obtaining unit 201 transmits the image to the detection unit 202.

The detection unit 202 generates a result of a detection by detecting the person from the image. The detection result is represented by a rectangular region (hereinafter referred to as a region) surrounding the person on the image. In addition, the detection result includes a plurality of the rectangular regions surrounding respective body parts of the face, the head, the chest, and the arm of the person. Further, the detection result includes information obtained by performing segmentation (image classification) on the regions of the person.

The detection unit 202 calculates a center coordinate (x, y), a width (w), and a height (h) of the region on the image, and a reliability of detection by using a machine learning method (for example, You Only Look Once (YOLO)). The width (w) and the height (h) are relative values with respect to the size of the entire image. The reliability of detection is represented by a probability indicating whether the region includes the person or a background. The reliability of detection takes, for example, a value of 1 in a case where the region represents the person and a value of 0 in a case where the region represents the background.

Note that the detection unit 202 calculates, but not limited to, the region of the face of the person and the region of the entire body of the person as the detection result of the person. The detection unit 202 may calculate, instead of the region of the face of the person, other body parts (such as the torso and the hand) of the person as the detection result of the person.

The discrimination unit 203 generates overlap information related to the two persons based on the detection result of the persons on an image 300. That is, the discrimination unit 203 generates overlap information based on a detection result of a person 301 (region 303) and a detection result of a person 305 (region 306). The overlap information (concealment information) includes an overlap flag and a position flag. Details of the overlap flag and the position flag will be described later.

The determination unit 204 calculates processing information based on the detection result of the person and the overlap information, which are obtained from the discrimination unit 203. The processing information is information of a processing range and a color set to the processing range. The processing range is a region set to a part or all of the region of the other person. The color is color information (for example, an RGB value) that is set (for example, painted) when the processing range is processed. In addition, the determination unit 204 calculates processing information of all the overlapping regions obtained from the detection result of the reference person and the detection result of each of the other persons. Note that the determination unit 204 may process the processing range not only by a specific image processing method but also by a method of modifying a feature amount of the image.

The processing unit 205 processes the image obtained by the obtaining unit 201 based on the detection result of the person and the processing information, and generates a processed image. The processing unit 205 generates all the processed images that can be obtained from the detection result of the reference person and the detection result of each of the other persons. The processing unit 205 selects one detection result of the reference person among the detection results of all the persons, and obtains processing information corresponding to the selected detection result of the reference person. The processing unit 205 sets the color (RGB value) determined by the determination unit 204 to all the processing ranges included in a list of the processing ranges, and generates the processed image. The processing unit 205 transmits the detection result of the person and the processed image to the estimation unit 206.

The estimation unit 206 estimates the posture of the person based on the detection result of the person and the processed image, and outputs a list of the joint points corresponding to the detection result of the person. The joint point is a position of a part of the person, such as the eye, the nose, the ear, the shoulder, the elbow, the wrist, the waist, the knee, the ankle, or the like. The estimation unit 206 calculates a coordinate of each of the joint points and the reliability of detection by using the machine learning. Note that the estimation unit 206 may detect the joint point from the processed image based on a method other than a specific posture estimation algorithm.

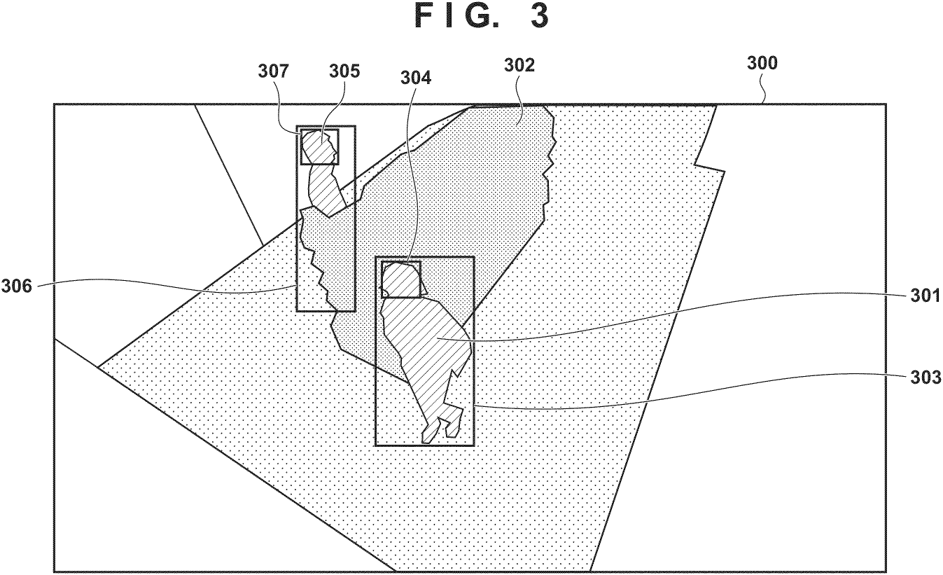

FIG. 3 is a diagram illustrating an example of the detection result of the persons on the image according to the first embodiment. The image 300 shows a person 301, a person 305, and a shielding material 302. The detection unit 202 detects a region 303, a region 304, a region 306, and a region 307 from the image 300 by using the machine learning. Then, the detection unit 202 transmits the detection result of the persons detected from the image 300 to the discrimination unit 203.

### Overlap Flag

The overlap flag is a flag indicating whether the detection result of the reference person and the detection result of the other person overlap each other. The discrimination unit 203 discriminates whether a region of the reference person and a region of the other person overlap each other based on whether IoU obtained from the detection result (the region) of the reference person and the detection result (the region) of the other person is equal to or greater than a threshold value. Here, Intersection over Union (IoU) is an index indicating how much the region of the reference person and the region of the other person overlap each other.

The discrimination unit 203 calculates the IoU by dividing a surface area of a portion where the region of the reference person and the region of the other person overlap each other by a union of sets (a surface area obtained by adding the region of the reference person and the region of the other person). In a case where the discrimination unit 203 discriminates that the value of the IoU is equal to or greater than the threshold value, the discrimination unit 203 sets the overlap flag to “True”. That is, in a case where the overlap flag is “True”, it is indicated that the overlapping region is present on the image. On the other hand, in a case where the discrimination unit 203 discriminates that the value of the IoU is less than the threshold value, the discrimination unit 203 sets the overlap flag to “False”. That is, in a case where the overlap flag is “False”, it is indicated that the overlapping region is not present on the image.

For example, in FIG. 3, in a case where the reference person is 301, the overlapping region in which the region 303 and the region 306 overlap each other is not present. Thus, the discrimination unit 203 calculates the overlapping region (surface area) between the region 303 and the region 306 as 0, discriminates that 0 is less than the threshold (for example, 1), and sets the overlap flag to “False”.

Note that in a case where the discrimination unit 203 discriminates that the surface area of the overlapping region is equal to or greater than 0, the discrimination unit 203 may set the overlap flag to True. That is, the discrimination unit 203 may discriminate the state of the overlap flag under a condition that allows discrimination of overlap between regions. Further, the overlap flag is represented in the form of the “True” and “False”, but may be represented by numerical values such as “0” and “1”. As described above, an expression format of the overlap flag is not limited to a specific format as long as a data format can express the presence or absence of the overlapping region.

### Position Flag

The position flag is a flag indicating whether the region of the other person is located below the region of the reference person. The discrimination unit 203 discriminates whether the region of the other person is located below the region of the reference person based on a comparison between a Y coordinate of the lowermost end of the region of the reference person and a Y coordinate of the lowermost end of the region of the other person.

First, the discrimination unit 203 calculates the Y coordinate of the lowermost end of the region of the reference person. Next, the discrimination unit 203 calculates the Y coordinate of the lowermost end of the region of the other person. In a case where the discrimination unit 203 discriminates that the Y coordinate of the lowermost end of the region of the other person is smaller than the Y coordinate of the lowermost end of the region of the reference person, the discrimination unit 203 sets the position flag to “True”. That is, in a case where the position flag is “True”, it is indicated that the region of the other person is located below the region of the reference person.

On the other hand, in a case where the discrimination unit 203 discriminates that the Y coordinate of the region of the other person is larger than the Y coordinate of the region of the reference person, the discrimination unit 203 sets the position flag to “False”. That is, in a case where the position flag is False, it is indicated that the region of the other person is located above the region of the reference person.

For example, in FIG. 3, in a case where the reference person is 301, it is discriminated that the Y coordinate (for example, 20) of the region 306 is larger than the Y coordinate (for example, 10) of the region 303, and the position flag is set to “False”. Finally, the discrimination unit 203 transmits the detection result of the person and the overlap information to the determination unit 204.

Note that the discrimination unit 203 may obtain the person located at the lowest position on the image based on the size of the region of the reference person or the other person and the coordinate value of the lower end of the segmentation region of the reference person or the other person. In this way, the discrimination unit 203 may discriminate the state of the position flag. The discrimination unit 203 may discriminate the state of the position flag by a method that can discriminate which person is located at the lowest position on the image. Further, the position flag is represented in the form of the “True” and “False”, but may be represented by the numerical values such as “0” and “1”. As described above, the expression format of the position flag is not limited to a specific format as long as a data format can express whether the other person is present below the reference person on the image.

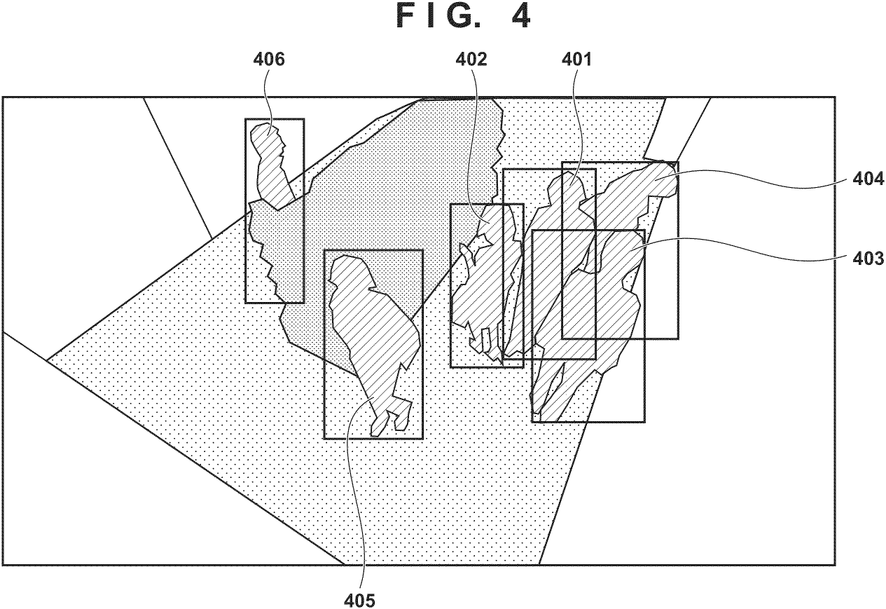

FIG. 4 is a diagram illustrating an example of a detection result of persons on an image according to the first embodiment. FIG. 4 illustrates a person 401 (reference person), a person 402, a person 403, a person 404, a person 405, and a person 406.

The discrimination unit 203 calculates overlap information of each region of the persons 402 to 406 with respect to the region of the person 401. Details of the overlap information (overlap flag, position flag) discriminated by the discrimination unit 203 will be described below. For example, according to the overlap information of the person 402, the overlap flag is “True” and the position flag is “True”. That is, the overlap information of the person 402 indicates that an overlapping region in which the region of the person 401 and the region of the person 402 overlap each other is present, and that the region of the person 402 is located below the region of the person 401. At this time, the person 401 is concealed by the person 402.

### Example of Overlap Information

Person 402 = (True, True)
Person 403 = (True, True)
Person 404 = (True, False)
Person 405 = (False, True)
Person 406 = (False, False)

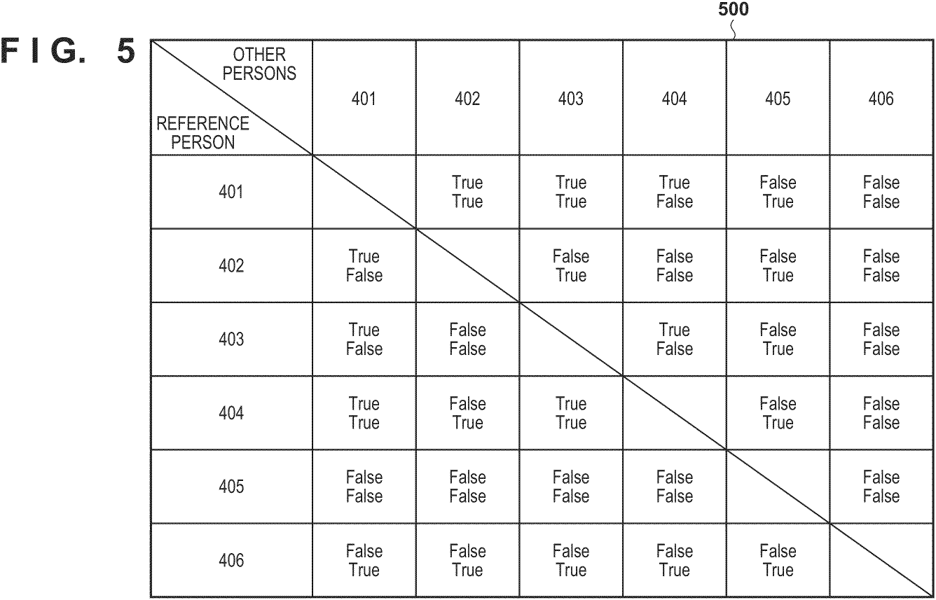

FIG. 5 is a diagram illustrating an example of an overlap information according to the first embodiment. A table 500 represents the relationship of the overlap information of the other persons (persons 401 to 406) with respect to the reference persons (persons 401 to 406). For example, in a case where the reference person is the person 401 and the other person is the person 402 in the table 500, the overlap information is (True, True). In each cell in the table 500, an upper row represents the overlap flag, and a lower row represents the position flag.

### Determination of Processing Range

The determination unit 204 selects one reference person from the table 500 and obtains the overlap information corresponding to the selected reference person (for example, the person 401). The determination unit 204 obtains the regions of the other persons (for example, the person 402 and the person 403) having the overlap information in which the overlap flag is “True” and the position flag is “True” in the table 500. Then, based on two overlapping regions which are a region of the person 401 overlapping the region of the person 402 and a region of the person 401 overlapping the region of the person 403, the determination unit 204 calculates the processing range to be processed for each of the regions of the person 402 and the person 403.

For example, in a case where the determination unit 204 has obtained information of the segmentation region of the reference person and the other person, the determination unit 204 calculates a region in which the segmentation regions of the reference person and the other person overlap each other as the overlapping region.

On the other hand, in a case where the determination unit 204 has not obtained the information of the segmentation regions of the reference person and the other person, the determination unit 204 calculates the IoU based on the detection result (region) of the reference person and the detection result (region) of the other person. In a case where the determination unit 204 discriminates that the IoU is equal to or greater than the threshold value, the determination unit 204 determines a region of a part (for example, a head) of the other person as the processing range. An effect in a case where the region of the head of the other person is set as the processing range will be described. A detection importance degree of the region of the head is high in a skeleton estimation, and thus in a case where the region of the head is set as the processing range, the feature amount of the other person can be effectively reduced. In addition, by setting the region of the head of the other person as the processing range, the feature amount of the reference person concealed by the other person does not decrease. In this way, the estimation unit 206 can estimate the joint point of the reference person on the processed image with high accuracy. Further, in a case the determination unit 204 discriminates that the IoU is not equal to or greater than the threshold value, the determination unit 204 determines the region of the whole body of the other person as the processing range.

Note that the detection unit 202 may detect only the other person whose segmentation region is determined as the processing range by the determination unit 204. That is, the detection unit 202 may first detect the region of the whole body of the other person, and further detect the segmentation region determined as the processing range.

The determination unit 204 may calculate the processing range based on the detected positions (coordinates) of the reference person and the other person. For example, in a case where the determination unit 204 discriminates that a difference between an X coordinate of the center of the region of the reference person and an X coordinate of the center of the region of the other person is equal to or greater than a first threshold value, the determination unit 204 may determine the region of the other person as the processing range. In addition, in a case where the determination unit 204 discriminates that the difference between the X coordinate of the center of the region of the reference person and the X coordinate of the center of the other person is equal to or greater than a second threshold value, the determination unit 204 may determine the region of the head of the other person as the processing range.

On the other hand, in a case where the determination unit 204 discriminates that the difference between the X coordinate of the center of the region of the reference person and the X coordinate of the center of the region of the other person is less than the second threshold value, the determination unit 204 may determine the region of the other person as the processing range. Note that the second threshold value is smaller than the first threshold value. Furthermore, the determination unit 204 may calculate the processing range based on a density of persons in the image (number of other persons located at a predetermined distance from the reference person).

For example, the determination unit 204 calculates the density (number of the other persons per unit surface area) by using the number of the other persons such that the Euclidean distance between the center coordinate of the region of the reference person and the center coordinate of the region of the other person is equal to or less than a threshold value. In a case where the determination unit 204 discriminates that the density is equal to or greater than a threshold value, the determination unit 204 determines the region of the other person as the processing range. Further, in a case where the determination unit 204 discriminates that the density is not equal to or greater than the threshold value, the determination unit 204 determines the region of the head of the other person as the processing range.

Furthermore, the determination unit 204 may calculate the processing range based on an assumed processing load. For example, the determination unit 204 calculates, as the assumed processing load, number of combinations of the region of the other person to be the setting target of the processing range. In a case where the determination unit 204 discriminates that the assumed processing load is equal to or greater than a threshold value, the determination unit 204 determines the region of the head of the other person as the processing range. On the other hand, in a case where determination unit 204 discriminates that the assumed processing load is not equal to or greater than the threshold value, the determination unit 204 determines the region of the other person as the processing range.

### Determination of Processing Method

The determination unit 204 determines a processing method for the processing range based on a color of clothes of the reference person. For example, the determination unit 204 calculates the color (RGB value) of the clothes of the reference person based on a pixel value of the region of the chest of the reference person in the region of the reference person. The determination unit 204 selects a color (RGB value) having the largest difference from the color of the clothes of the reference person, and sets (for example, paints) the selected color (RGB value) to the processing range. The determination unit 204 obtains processing information of an overlapping region (processing range) in which the region of each of the other persons overlaps the reference person. The determination unit 204 transmits the detection result of the persons and the processing information to the processing unit 205.

Note that the determination unit 204 may determine the color to be set (painted) to the processing range based on the color information in a periphery of the processing range and a color of a specific part of the other person. The determination unit 204 performs, for example, deformation, color conversion, softening, and mosaic processing on the processing range. The deformation is a process of changing the shape of the image by homography transformation, a waving processing, a spiral processing, or the like.

The determination unit 204 deforms the shape of the image based on the strength and type of the deformation. The color conversion is a process of changing luminance, saturation, contrast, color temperature, hue, or the like of the image. The determination unit 204 performs color conversion based on the amount of change in luminance, saturation, or the like. The softening is a process of softening the image by a Gaussian filter, a smoothing filter, or the like. The determination unit 204 performs softening processing of the image based on the size and strength of the filter.

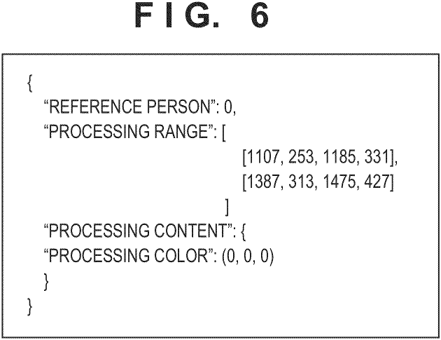

FIG. 6 is a diagram illustrating an example of the processing information according to the first embodiment. The processing information includes an index representing the reference person, the list of processing ranges, and a processing content (color information). The index representing the reference person is “0”. The processing range (x, y, w, h) is [1107, 253, 1185, 331] and [1387, 313, 1475, 427]. The processing color is an RGB value (0, 0, 0). Note that the RGB value (0, 0, 0) represents black.

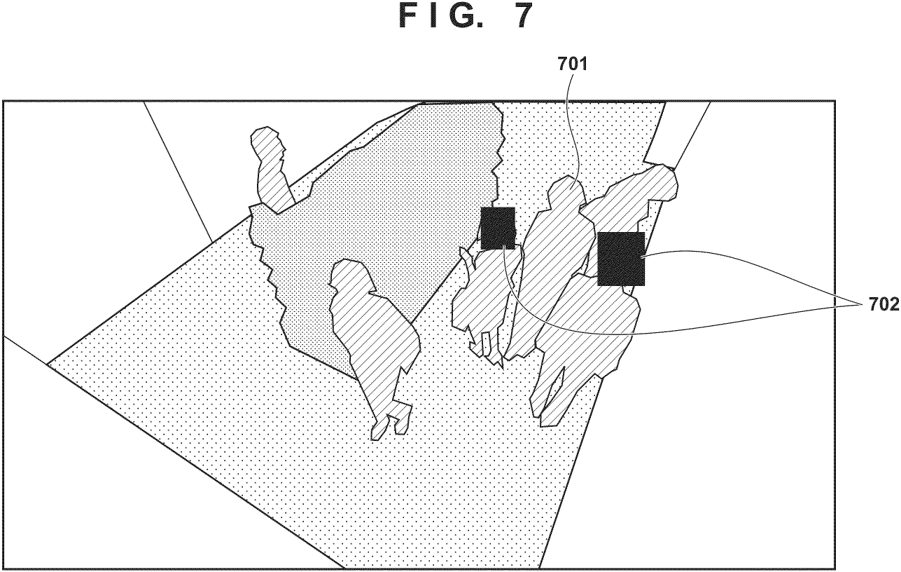

FIG. 7 is a diagram illustrating an example of the processed image according to the first embodiment. In a case where the person 701 is set as the reference person, the processing unit 205 sets the color (RGB value (0, 0, 0)) to the processing range 702 based on the processing information and generates the processed image. Note that the processing range 702 is two black rectangular regions.

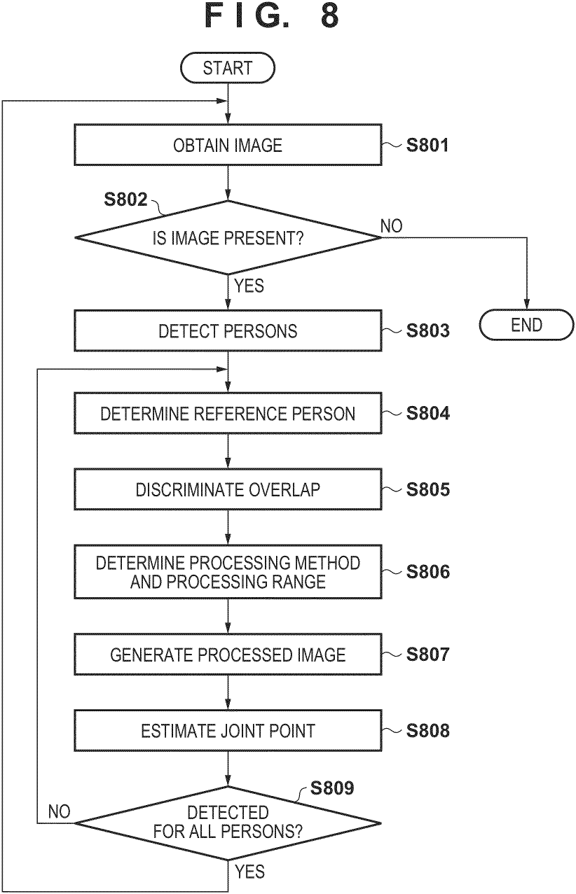

FIG. 8 is a flowchart explaining a flow of the image processing according to the first embodiment.

In S801, the obtaining unit 201 obtains an image from the HDD 107 or the like.

In S802, the detection unit 202 discriminates whether an image to be processed is present. If the detection unit 202 discriminates that the image is not present (No in S802), then the processing ends. If the detection unit 202 discriminates that the image is present (Yes in S802), then the processing proceeds to S803.

In S803, the detection unit 202 detects all persons on the image.

In S804, the discrimination unit 203 determines the reference person from the detection results of all the persons.

In S805, the discrimination unit 203 discriminates overlap between the reference person and the other persons on the image, based on the detection results of all the persons, and generates the overlap information.

In S806, the determination unit 204 determines the processing ranges to be processed for the regions of the other persons and the processing information to be set to the processing ranges, based on the overlap information.

In S807, the processing unit 205 generates the processed image by processing the processing range on the image based on the processing information.

In S808, the estimation unit 206 estimates the joint point of the reference person on the processed image.

In S809, the estimation unit 206 discriminates whether the joint points of all the reference persons on the processed image are detected. If the estimation unit 206 discriminates that the joint points of all the reference persons on the processed image are detected (Yes in S809), then the processing returns to S801. If the estimation unit 206 discriminates that the joint points of all the reference persons on the processed image are not detected (No in S809), then the processing returns to S804.

As described above, according to the first embodiment, the processing region and the processing method for the region of the other person can be determined based on the overlap information obtained by discriminating the overlap between the region of the reference person and the region of the other person. In this way, the joint point of the reference person on the processed image obtained by processing the region of the other person can be accurately detected.

### Second Embodiment

In a second embodiment, postures of the reference person and the other person are estimated from an image captured by an image capturing device, and a processed image is generated based on a posture estimation result. In the second embodiment, the joint point of the reference person is further detected from the processed image. The second embodiment will be described, focusing on only the difference from the first embodiment.

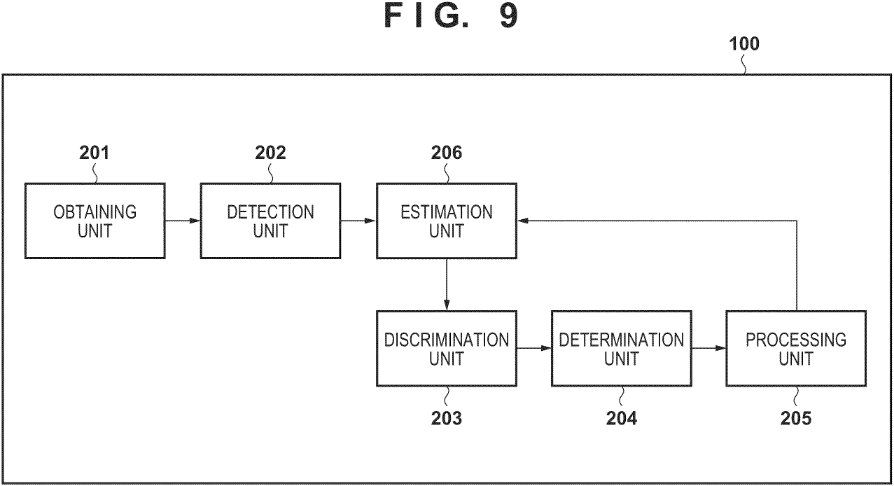

FIG. 9 is a block diagram illustrating an example of a functional configuration of the image processing device according to the second embodiment. The second embodiment has the functional configuration similar to that of the first embodiment, but is different from the first embodiment in the arrangement of the discrimination unit 203 to the estimation unit 206. Specifically, in the second embodiment, the discrimination unit 203 generates the overlap information based on the estimation result by the estimation unit 206, and the estimation unit 206 estimates the joint point of the reference person based on the result of the determination by the processing unit 205. That is, the estimation unit 206 performs the estimation processing of the joint point of the reference person on the image twice.

The discrimination unit 203 discriminates overlap between the region of the j oint point of the reference person and the region of the j oint point of the other person based on the posture estimation result obtained by estimating the posture of the reference person by the estimation unit 206, and generates the overlap information. The discrimination unit 203 calculates the IoU between the region of the j oint point of the reference person and the region of the j oint point of the other person, and discriminates the state of the overlap flag based on whether the IoU is equal to or greater than the threshold value.

The discrimination unit 203 sets a median value of the joint point of the ankle of the reference person as the Y coordinate, and sets a median value of the joint point of the ankle of the other person as the Y coordinate. The discrimination unit 203 discriminates the state of the position flag based on the comparison between the Y coordinate of the reference person and the Y coordinate of the other person. For example, in a case where the discrimination unit 203 discriminates that the Y coordinate of the reference person is smaller than the Y coordinate of the other person, the discrimination unit 203 sets the position flag to “False”. On the other hand, in a case where the discrimination unit 203 discriminates that the Y coordinate of the reference person is larger than the Y coordinate of the other person, the discrimination unit 203 sets the position flag to “True”. The discrimination unit 203 sends the posture estimation result and the overlap information to the determination unit 204.

The determination unit 204 calculates the processing information based on the posture estimation result and the overlap information obtained by the discrimination unit 203. The determination unit 204 determines the processing range with respect to the region of the joint points of the other person based on the joint points included in the posture estimation result. First, the determination unit 204 converts the joint points into skeleton information by connecting the joint points with lines based on a joint definition. For example, an arm skeleton is represented by a line connecting the shoulder, the elbow, and the wrist. The determination unit 204 calculates, for each line of the skeleton information, an ellipse whose long side is a length of each line, and lists each ellipse as a candidate of the processing range.

Here, the determination unit 204 compares the list of the ellipses of the reference person with the list of the ellipses of the other person, and in a case where the ellipse of the reference person overlaps the ellipse of the other person, the ellipse is left in the list as the candidate of the processing range. Note that similarly to the first embodiment, in a case where the IoU obtained based on the comparison between the ellipse of the reference person and the ellipse of the other person is equal to or greater than the threshold value, the determination unit 204 may determine a part of the region of the ellipse of the other person as the processing range. On the other hand, in a case where the ellipse of the reference person and the ellipse of the other person do not overlap each other, the determination unit 204 excludes the ellipse from the list.

Alternatively, in a case where the determination unit 204 discriminates that each detection reliability of the joint points forming each skeleton of the reference person and the joint points forming each skeleton of the other person is equal to or greater than the threshold value, the determination unit 204 determines the ellipse as the processing range. in a case where the determination unit 204 discriminates that each detection reliability of the joint points forming each skeleton of the reference person and the joint points forming each skeleton of the other person is not equal to or greater than the threshold value, the determination unit 204 does not determine the ellipse as the processing range.

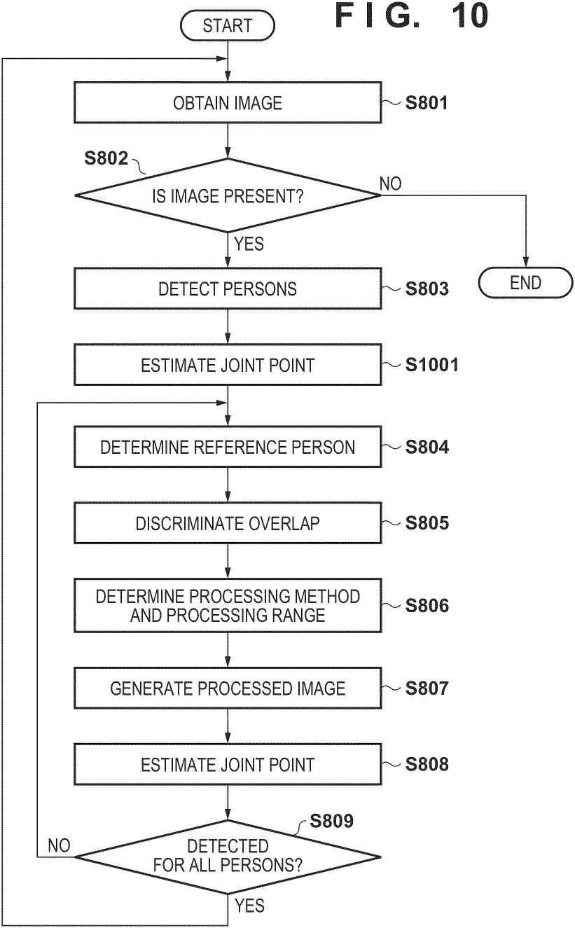

FIG. 10 is a flowchart explaining a flow of image processing according to the second embodiment. FIG. 10 is the flowchart in which S1001 is added between S803 and S804 in FIG. 8.

In S1001, the estimation unit 206 estimates the joint points of all the persons on the image based on the detection results of the persons.

As described above, according to the second embodiment, the processing region and the processing method for the regions of the joint points of the other persons can be determined based on the overlap information obtained by discriminating the overlap between the region of the joint points of the reference person and the regions of the joint points of the other persons. In this way, the joint points of the reference person on the processed image obtained by processing the regions of the joint points of the other persons can be accurately detected.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No.2022-034769, filed Mar. 7, 2022, which is hereby incorporated by reference herein in its entirety.

What is claimed is:

1. An image processing device comprising:
a determination unit configured to determine, in a case where a reference person on an image is concealed by another person, a part or all of a region of the other person on the image as a processing region in accordance with a state of the concealment;
an estimation unit configured to estimate a joint point of the reference person on a processed image obtained by performing a process of processing the processing region on the image.

2. The image processing device according to claim 1, further comprising a generating unit configured to generate concealment information obtained by determining whether a region of the reference person is concealed by the region of the other person and whether the region of the other person is located below the region of the reference person on the image based on the region of the reference person and the region of the other person on the image.

3. The image processing device according to claim 1, wherein the process of processing the processing region is at least one of deformation, color conversion, softening, and mosaic processing.

4. The image processing device according to claim 1, further comprising a detection unit configured to detect the reference person and the other person on the image.

5. The image processing device according to claim 1, wherein the determination unit determines color information to be set to the processing region based on color information of at least one of clothes of the reference person, a part of the other person, and a periphery of the processing region, and the estimation unit performs a process of processing the processing region on the image based on a result of a determination by the determination unit.

6. The image processing device according to claim 1, wherein, in a case where a size of a portion overlapping the region of the reference person in the region of the other person exceeds a threshold value, the determination unit determines a part of the region of the other person as the processing region.

7. The image processing device according to claim 1, wherein, in a case where a size of a portion overlapping the region of the reference person in the region of the other person does not exceed a threshold value, the determination unit determines all of the region of the other person as the processing region.

8. The image processing device according to claim 2, wherein the determination unit determines a size of the processing region based on at least one of a size of a portion overlapping the region of the reference person in the region of the other person, a position of the region of the other person with respect to the region of the reference person, a distance between a center coordinate of the region of the reference person and a center coordinate of the region of the other person, and number of the other persons concealing the reference person.

9. The image processing device according to claim 1, wherein
the estimation unit estimates a joint point of the reference person and a joint point of the other person on the image,
in a case where the joint point of the reference person is concealed by the joint point of the other person, the determination unit determines a part or all of the joint points of the other person on the image as the processing region according to a state of the concealment, and
the estimation unit further estimates the joint point of the reference person on a processed image obtained by performing a process of processing the processing region on the image.

10. The image processing device according to claim 9, wherein the determination unit determines a size of the processing region based on at least one of a size of a portion overlapping a region of the joint point of the reference person in the region of the joint point of the other person, a position of the region of the joint point of the other person with respect to the region of the joint point of the reference person, a distance between a center coordinate of the region of the joint point of the reference person and a center coordinate of the region of the joint point of the other person, and number of the regions of the joint points of the other persons concealing the region of the joint point of the reference person.

11. The image processing device according to claim 9, wherein, in a case where detection reliability of each of a region of the joint point of the reference person and a region of the joint point of the other person on the image is less than a threshold value, the determination unit determines a part of the region of the joint points of the other person as the processing region.

12. The image processing device according to claim 8, wherein, in a case where detection reliability of each of a region of the joint points of the reference person and a region of the joint points of the other person on the image is greater than a threshold value, the determination unit determines all of the regions of the joint points of the other person as the processing region.

13. An image processing method comprising:
determining, in a case where a reference person on an image is concealed by another person, a part or all of a region of the other person on the image as a processing region in accordance with a state of the concealment;
estimating a joint point of the reference person on a processed image obtained by performing a process of processing the processing region on the image.

14. A non-transitory computer-readable storage medium storing a program that, when executed by a computer, causes the computer to perform an image processing method comprising:
determining, in a case where a reference person on an image is concealed by another person, a part or all of a region of the other person on the image as a processing region in accordance with a state of the concealment;
estimating a joint point of the reference person on a processed image obtained by performing a process of processing the processing region on the image.
